(19) United States
(12) Patent Application Publication
(10) Pub. No.: US 2024/0140368 A1
(43) Pub. Date: May 2, 2024

(54) VEHICLE SENSOR CLEANING APPARATUS AND CONTROL METHOD THEREOF

(71) Applicants: DY AUTO Corporation, Asan-si (KR); DY-ESSYS Corp., Incheon (KR)

(72) Inventors: Jong Wook Lee, Asan-si (KR); Sin Won Kang, Asan-si (KR); Seong Jun Kim, Asan-si (KR); Kyung Seon Min, Asan-si (KR); Gyu Seon Lee, Asan-si (KR); Jong Hyun Jin, Asan-si (KR); Min Wook Park, Incheon (KR); Je Min Mun, Incheon (KR); Sun Ju Kim, Incheon (KR); Ki Chan Lee, Incheon (KR)

(73) Assignees: DY AUTO Corporation, Asan-si (KR); DY-ESSYS Corp., Incheon (KR)

(21) Appl. No.: 18/383,867

(22) Filed: Oct. 25, 2023

(30) Foreign Application Priority Data
Nov. 2, 2022 (KR) 10-2022-0144616

(51) Int. Cl. B60S 1/56; B60S 1/48; B60S 1/54

(52) U.S. Cl. CPC B60S 1/56; B60S 1/481; B60S 1/54

(57) ABSTRACT

Provided are a vehicle sensor cleaning apparatus and a control method thereof. The vehicle sensor cleaning apparatus includes a liquid sprayer configured to spray washer fluid on at least one sensor arranged in a vehicle, an air sprayer configured to spray air on the at least one sensor, a liquid controller configured to control washer fluid spraying of the liquid sprayer, and an air controller configured to control air spraying of the air sprayer.

### CROSS-REFERENCE TO RELATED APPLICATION

This application is based on and claims priority under 35 U.S.C. § 119 to Korean Patent Application No. 10-2022-0144616, filed on Nov. 2, 2022, in the Korean Intellectual Property Office, the disclosure of which is incorporated by reference herein in its entirety.

### BACKGROUND

### 1. Field

The disclosure relates to a vehicle sensor cleaning apparatus for cleaning a sensor installed on a vehicle and a control method thereof.

### 2. Description of the Related Art

Recent vehicles include various types of sensors (cameras, radars, lidars, etc.) A vehicle sensor may not work normally if a foreign object is on the surface of the vehicle sensor. If the sensors necessary for autonomous driving or various driving assistance do not work normally, this can also affect the safety of vehicle operation. Although a system that emits washer fluid to remove foreign substances of a vehicle windshield has been used, it is difficult to employ the washer fluid emitting system to clean small sensors located in various portions of a vehicle and having small sizes.

### SUMMARY

The disclosure provides a vehicle sensor cleaning apparatus for removing foreign materials on a sensor surface included in a vehicle and a control method of the sensor clearing apparatus.

Additional aspects will be set forth in part in the description which follows and, in part, will be apparent from the description, or may be learned by practice of the presented embodiments of the disclosure.

According to an embodiment, a vehicle sensor cleaning apparatus includes a liquid sprayer configured to spray washer fluid on at least one sensor arranged in a vehicle, an air sprayer configured to spray air on the at least one sensor, a liquid controller configured to control washer fluid spraying of the liquid sprayer, and an air controller configured to control air spraying of the air sprayer.

According to an embodiment, a control method of a vehicle sensor cleaning apparatus includes receiving a cleaning request from a vehicle controller, spraying washer fluid on at the least one sensor according to the cleaning request, and spraying air on at least one sensor according to the cleaning request.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view of an example of an overall structure of a vehicle sensor cleaning apparatus, according to an embodiment,

FIG. 2 is a view of an example of a cleaning direction of a sensor, according to an embodiment;

FIG. 3 is a view of an example of a detailed structure of an air sprayer, according to an embodiment;

FIG. 4 is a view of an example of a detailed structure of a liquid sprayer, according to art embodiment;

FIG. 5 is a view of an example of a method of controlling a vehicle sensor cleaning apparatus, according to an embodiment;

FIG. 6 is a view of an example of a method of alternately controlling a vehicle sensor cleaning apparatus, according to an embodiment;

FIG. 7 is a view of an example of a vehicle including a vehicle sensor cleaning apparatus, according to an embodiment; and

FIG. 8 is a view of another example of a vehicle sensor cleaning apparatus, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a vehicle sensor cleaning apparatus and a method of controlling the apparatus, according to an embodiment, will be described in detail with reference to the accompanying drawings.

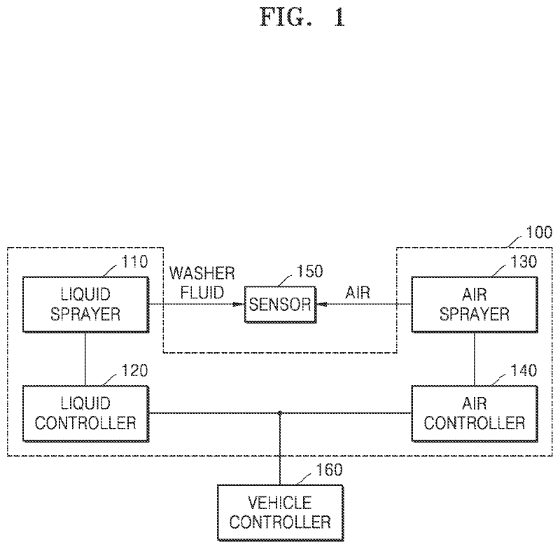

FIG. 1 is a view of an example of an overall structure of a vehicle sensor cleaning apparatus, according to an embodiment.

Referring to FIG. 1, a vehicle sensor cleaning apparatus 100 may include a liquid sprayer 110, a liquid controller 120, an air sprayer 130, and an air controller 140. The vehicle sensor cleaning apparatus 100 may be connected to a vehicle controller 160. In some embodiments, a gateway (not shown) that transmits a cleaning request of the vehicle controller 160 to each of t ye liquid controller 120 and the air controller 140 may further be included.

The liquid sprayer 110 may spray washer fluid on a sensor 150. The washer fluid may include various components according to an embodiment. For example, the washer fluid may include various components such as general water or components identical to those used in a vehicle glass.

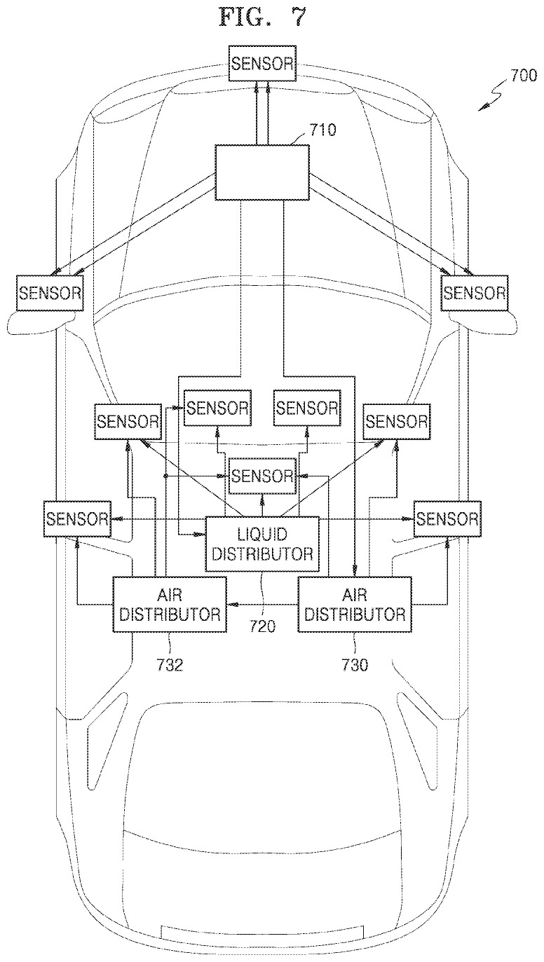

The present embodiment shows only one sensor 150 for convenience of explanation, but a vehicle may include a plurality of sensors as shown in FIG. 7. The liquid sprayer 110 may spray washer fluids simultaneously or sequentially on a plurality of sensors, or spray washer fluids only on sensors that require cleaning, and, in this regard, an example of a configuration of the liquid sprayer 110 is shown in FIG. 4.

The liquid controller 120 may control the washer fluid spraying of the liquid sprayer 110. For example, when the liquid controller 120 receives a cleaning request from the vehicle controller 160, the liquid controller 120 may control the liquid sprayer 110 to spray the washer fluid. The controlling of the spraying of washer fluid on a plurality of sensors will be described again with respect to FIG. 4.

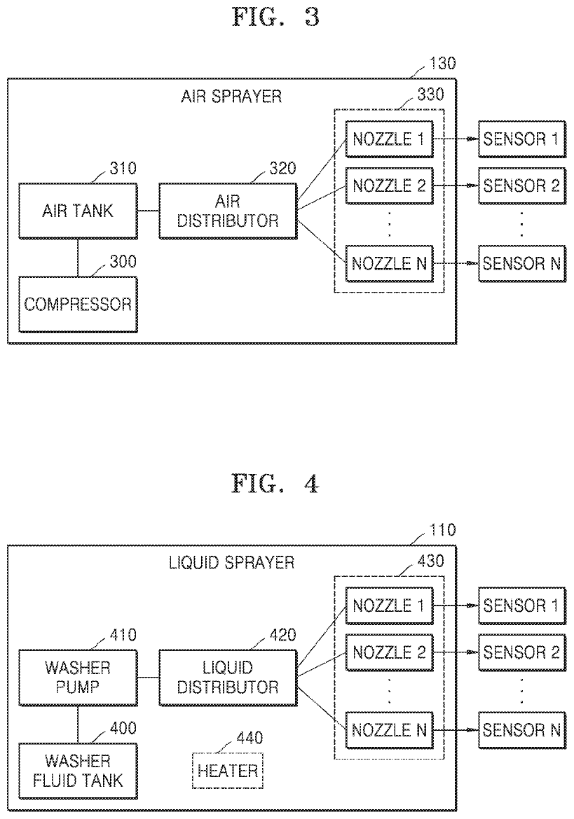

The air sprayer 130 may spray air on the sensor 150, Since there are a plurality of sensors in the vehicle, the air sprayer 130 may simultaneously or sequentially spray air on the plurality of sensors, or spray air only on sensors that require cleaning, and, in this regard, an example of a configuration of the air sprayer 130 is shown in FIG. 3. Air sprayed on the sensor may be general air or compressed air. FIG. 3 is an example of spraying compressed air.

The air controller 140 may control the spraying of air of the air sprayer 130. For example, when the air controller 140 receives a cleaning request from the vehicle controller 160, the air controller 140 may control the air sprayer 130 to spray air. The controlling of the spraying of air on a plurality of sensors will be described again in FIG. 3.

The vehicle controller 160 may output a cleaning request command if the sensor 150 requires cleaning. For example, the vehicle controller 160 may identify a sensor that requires cleaning through various conventional methods. Because the method of identifying a sensor that requires cleaning exceeds the range of the disclosure, descriptions regarding this matter is omitted. The present embodiment is described assuming that the liquid controller 120 and the air controller 140 receive cleaning requests including sensor identification information from the vehicle controller 160.

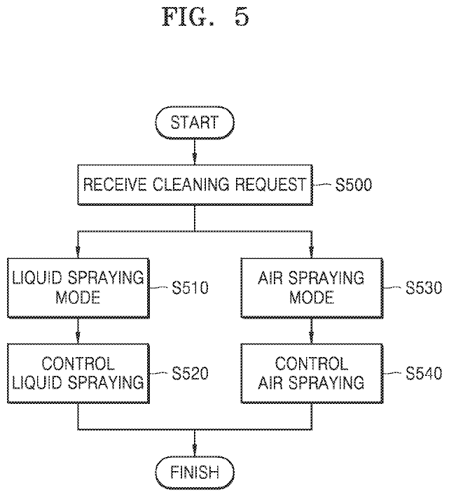

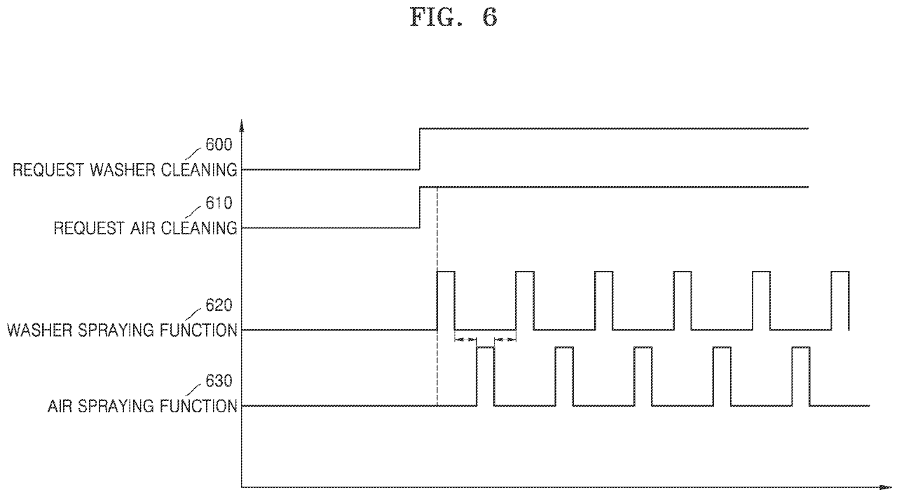

The vehicle controller 160 only outputs the cleaning request and does not limit the cleaning method. Therefore, according to the cleaning request, the method of cleaning each sensor may be implemented variously. The present embodiment provides a method of performing cleaning through spraying washer fluid and air when a cleaning request is received. For the sensor cleaning to be performed efficiently, the spraying of washer fluid and air may not be performed simultaneously. For example, a separate central controller for controlling the liquid controller 120 and the air controller 140 may be provided, but in this case, there may be an increase in manufacturing costs due to adding the central controller and there may be difficulties in implementing a hardware. The present embodiment presents a method of controlling the spraying operation of the liquid sprayer 110 and the air sprayer 130 without adding a separate hardware, the method to be described in FIGS. 5 and 6,

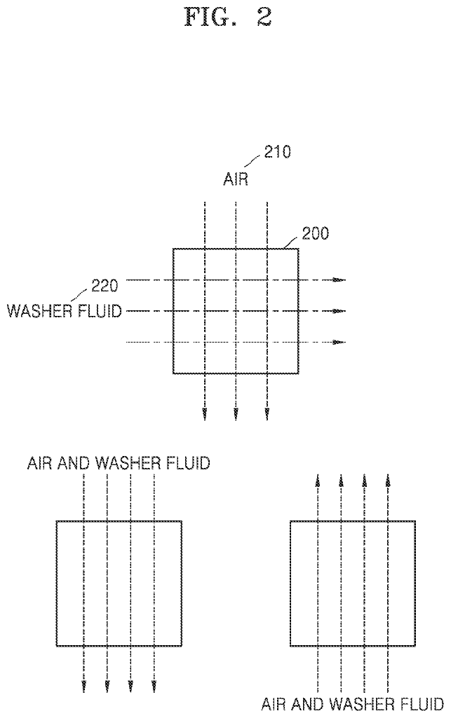

FIG. 2 is a view of an example of a cleaning direction of the sensor, according to an embodiment.

Referring to FIG. 2, a direction of the washer fluid 220 sprayed on the surface of the sensor 200 and a direction of the air 210 may be different. In addition, the washer fluid and air may be sprayed simultaneously or sequentially, or only one of the washer fluid and air may be sprayed. For example, the liquid sprayer 110 may spray the washer fluid from the left to the right with respect to the sensor 200, and the air sprayer may spray air from the top to the bottom of the sensor 200. The washer fluid and air sprayed in different directions may effectively remove foreign materials on the surface of the sensor. For example, air may be sprayed from the top to the bottom to remove the washer fluid or rainwater left on the surface of the sensor.

In another embodiment, a direction of the washer fluid 220 sprayed on the surface of the sensor 200 and a direction of the air 210 may be different. For example, the washer fluid and air may be sprayed from the top to the bottom (or from the bottom to the top) of the sensor. Through the simultaneous spraying of the washer fluid and air, the pressure on the surface of the sensor may be increased to effectively remove foreign materials on the surface.

FIG. 3 is a view of an example of a detailed structure of the air sprayer, according to an embodiment.

Referring to FIG. 3, the air sprayer 130 may include a compressor 300, an air ank 310, an air distributor 320, and a plurality of nozzles 330.

The compressor 300 may compress and stores air in the air tank 310. In an embodiment, the compressor 300 may include a plurality of motors. In this case, the compressor 300 may alternately use a plurality of motors to prevent a load from being added to one motor. A compressor 300 including one motor may be implemented. In some embodiments, a compression intensity of air stored in the air tank 310 may be adjusted through the compressor 300.

The air tank 310 may store the compressed air. In an embodiment, air may be sprayed on the sensor by using a propeller, etc. without the compressor 300 and the air tank 310. However, since the intensity of air generated through the propeller, etc. is weak, it is difficult to cleanly remove foreign materials or water on the surface of the sensor. Therefore, the present embodiment may increase the intensity (e.g., the speed) of air sprayed on the sensor by using compressed air stored in the air tank 310.

The air distributor 320 may distribute compressed air output from the air tank 310 to the plurality of nozzles 300. The nozzles 330 may be respectively arranged in the sensors and spray air on the sensors. In an example, the air distributor 320 may include a plurality of channels that output compressed air, and the channels are respectively connected to the nozzles 330 through air hoses. If the number of sensors becomes greater than the number of channels of the air distributor 320, a plurality of air distributors 320 may be provided. For example, the plurality of air distributors 320 may each be connected in parallel to the air tank 310, or the plurality of air distributors 320 may be connected to each other in a hierarchical structure such as a tree structure.

The air controller 140 may control the air distributor 320 to turn onloff each channel. For example, when the air distributor 320 receives an on command of a first channel from the air controller 140, the air distributor 320 may output compressed air of the air tank 310 through the first channel, and a first nozzle connected to the first channel through an air hose may spray air on a first sensor.

To control the performance of the air distributor 320 of turning each channel onloff, the air controller 140 may identify and store, in advance, which channel of the air distributor 320 each sensor is connected to. For example, if a relationship between first sensor identification information and the first channel is defined, when cleaning of the first sensor is required, the air controller 140 may transmit the on command of the first channel of the air distributor 320 to the air distributor 320.

In some embodiments, the air controller 140 may control the intensity of air according to the external environment. For example, the higher the increase of vehicle speed, the greater the increase in driving wind, and thus, the air controller 140 may lessen the spraying intensity of air or may not spray air when the vehicle speed increases. Therefore, the air controller 140 may adjust the compression intensity of compressed air stored in the air tank 310 by using the compressor 300 after defining information about the intensity of compressed air for each vehicle speed. In another example, the air controller 140 may control the number of air spraying or the spraying intensity of air differently according to the amount of rain. For example, the air controller 140 may control the air distributor 320 to remove rainwater, etc. on the surface of the sensor even faster when there is even more amount of rain. To this end, the air controller 140 may define and store information about the amount of rainwater and the number of spraying or the intensity of spraying of air in advance. The air controller 140 may receive information such as the amount of rainwater or vehicle speed from the vehicle controller 160 or from various devices of the vehicle.

FIG. 4 is a view of an example of a detailed structure of the liquid sprayer, according to an embodiment.

Referring to FIG. 4, the liquid sprayer 110 may include a washer fluid tank 400, a washer pump 410, a liquid distributor 420, and at least one nozzle 430.

The washer fluid tank 400 stores the washer fluid. The washer pump 410 may output the washer fluid stored in the washer fluid tank 400 to the liquid distributor 420. The liquid distributor 420 may output the washer fluid received through the washer pump 410 through the nozzle 430. The nozzle 430 may spray the washer fluid on the sensor. Each nozzle 430 may be connected to the liquid distributor 420 through a liquid hose.

The liquid distributor 420 may select the nozzle 430 to output the washer fluid according to the control of the liquid controller 120. In an example, the liquid distributor 420 may include a plurality of channels that output the washer fluid, and the channels are respectively connected to the nozzles 430 through liquid hoses. If the number of sensors becomes greater than the number of channels of the liquid distributor 420, a plurality of liquid distributors 420 may be provided. For example, the plurality of liquid distributors 420 may each be connected in parallel to the washer pump 410, or the plurality of liquid distributors 420 may be connected to each other in a hierarchical structure such as a tree structure.

The liquid distributor 420 may spray the washer fluid on the desired sensor by turning ontoff the plurality of channels. When the liquid distributor 420 receives the on command of the first channel from the liquid controller 120, the washer fluid is output through the first channel, and the first nozzle connected to the first channel may spray the washer fluid on the first sensor. The liquid controller 120 may identify and store in advance which channel of the liquid distributor 420 each sensor is connected to, like the air controller 140 described above. For example, if a relationship between the first sensor identification information and the first channel is defined in advance, when cleaning of the first sensor is required, the liquid controller 120 may transmit the on command of the first channel of the liquid distributor 420 to the liquid distributor 420.

In some embodiments, the liquid sprayer 110 may further include a heater 440. The heater 440 may supply heat to the liquid hose connecting each nozzle 430 to the liquid distributor 420, the washer pump 410, the washer fluid tank 400, or the liquid distributor 420. For example, when the external temperature is low, such as in winter, etc., the washer fluid in the liquid hose or liquid distributor 420 may freeze, and thus, the heater 440 may prevent the washer fluid from being frozen. In an embodiment, the liquid controller 120 may operate the heater 440 when the liquid controller 120 receives a command to operate the heater 400 or when an external temperature identified through a temperature sensor is less than a preset temperature.

In another embodiment, the liquid controller 120 may control the amount of spraying or the spraying intensity of the washer fluid according to the external environmental conditions. For example, the faster the vehicle speed, the more the driving wind increases, and thus, a higher spraying intensity is required. Therefore, the liquid controller 120 may store information about the spraying intensity according to the vehicle speed in advance, and then control the washer pump 410 according to the current vehicle speed to control the spraying intensity of the washer fluid. In another example, the liquid controller 140 may control the number of the spraying or the spraying intensity of the washer fluid differently according to the amount of rain. If there is a lot of rain, the spraying of the washer fluid may become unnecessary. To this end, the liquid controller 120 may define and store, in advance, information about the number of spraying or the intensity of spraying according to the amount of rain.

FIG. 5 is a view of an example of a method of controlling the vehicle sensor cleaning apparatus, according to an embodiment.

Referring to FIGS. 1 and 5, the liquid controller 120 and the air controller 140 may each receive a cleaning request S500. The liquid controller 120 may identify whether it is possible to perform a liquid spraying mode in which the washer fluid is sprayed on a certain sensor included in the cleaning request S510. For example, the liquid controller 120 may be connected to the air′ controller 140 and may receive information about whether an air spraying operation is being performed from the air controller 140. If the air controller 140 is not in an air spraying mode, the liquid controller 120 may turn into the liquid spraying mode S510 and may spray the washer fluid on the sensor S520. In addition, during the liquid spraying mode, the liquid controller 120 may inform the air sprayer 140 that the liquid spraying operation is being performed. In some embodiments, if the washer fluid spraying is unnecessary due to rain, the liquid controller 120 may not perform the operation even when the cleaning request is received. The liquid controller 120 may receive information about the amount of rainwater, etc. from the vehicle controller or from various devices in the vehicle.

The air controller 140 may identify whether it is possible to perform an air spraying mode included in the cleaning request and in which air is sprayed on a certain sensor S520. For example, the air controller 140 may receive information about whether the washer fluid spraying operation is being performed from the liquid controller 120. The air controller 140 may turn into the air spraying mode when the liquid controller 120 is not in the liquid spraying mode. For example, if the liquid controller 120 is performing the washer fluid spraying, the air controller 140 may wait until information regarding finishing of the washer fluid spraying operation is received from the liquid controller. In the air spraying mode, the air controller 140 may inform the liquid controller 120 that the air spraying operation is being performed. In addition, the air controller 140 may spray air on the sensor through the air sprayer 130 S530. In some embodiments, if the air fluid spraying is unnecessary because the speed of the vehicle is equal to or greater than a certain speed, the air controller 140 may not perform the operation even when the cleaning request is received. The air controller 140 may receive information about the speed of the vehicle, etc. from the vehicle controller or from various devices in the vehicle.

In some embodiments, the liquid controller 120 and the air controller 140 may alternately operate without having to identify whether each other's operations are being performed. The details thereof are described in FIG. 6.

FIG. 6 is a view of an example of a method of alternately controlling the vehicle sensor cleaning apparatus, according to an embodiment.

Referring to FIGS. 1 and 6, the liquid controller 120 and the air controller 140 may receive cleaning requests 600 and 610 from the vehicle controller. The liquid controller 120 and the air controller 140 may be connected to the vehicle controller 160 through a controller area network (CAN) or a CAN with flexible data rat (CAN FD).

To prevent the washer fluid spraying and the air spraying from being performed at the same time, the point of controlling of the washer fluid spraying liquid controller 120 and the point of controlling the air spraying may be different from each other. For example, when the liquid controller 140 receives the cleaning request 600, a washer fluid spraying function 620 is performed immediately. When the air controller 140 receives the cleaning request 610, an air spraying function 630 is performed after a predetermined period passes. In other words, there is a certain time interval between a starting point of the washer fluid spraying operation and a starting point of the air spraying operation.

In an embodiment, the liquid controller 120 may control the liquid sprayer 110 to spray the washer fluid for t1 hours after receiving the cleaning request 600, and the air controller 140 may control the air sprayer 130 to spray air t1 hours after receiving the cleaning request 600.

In some embodiments, the washer fluid spraying and the air spraying may be controlled to be alternately repeated. The control signal for the washer fluid spraying function 620 and the air spraying function 630 of the present embodiment may be a control signal for alternate controlling. The liquid controller 120 may repeat the washer fluid spraying operation at regular intervals, and the air controller 140 may also repeat the air spraying operation at regular intervals. For example, the liquid controller 120 and the air controller 140 may output periodically the on signal for the spraying operation at regular intervals. The washer fluid spraying or the air spraying may be performed during an on-signal section, and the washer fluid spraying or the air spraying may not be performed during an off-signal section.

An operation cycle of the liquid controller 120 and the air controller 140 may be the same. When a washer fluid spraying operation point and an air spraying operation point are different, the duration of the two operations are the same, and the on-signal section of the washer fluid spraying does not overlap the on-signal section of the air spraying, the washer fluid spraying operation and the air spraying operation may not overlap in time and be alternately performed.

FIG. 7 is a view of an example of a vehicle in which the vehicle sensor cleaning apparatus is implemented, according to an embodiment.

Referring to FIG. 7, a plurality of sensors are provided in a vehicle 700. The air tank and the washer fluid tank shown in FIGS. 3 and 4 are included in one side 710 of the vehicle. The present embodiment shows a case in which the air tank and the washer fluid tank are arranged in one location, but this is only an example, and the air tank and the washer fluid tank may be arranged in different locations of the vehicle. In some embodiments, a plurality of air tanks and a plurality of washer fluid tanks may be provided.

Each sensor is arranged in the nozzle of FIGS. 3 and 4. Air is sprayed on the sensor through the air nozzle of FIG. 3, and the washer fluid is sprayed on the sensor through the liquid nozzle of FIG. 4.

One or more air distributors 730 and 732 may be provided for supplying compressed air of the air tank to the air nozzle arranged in each sensor. The air controller may spray air on the desired sensor by controlling the air distributor 730 and 732.

One or more liquid distributors 720 may be provided for supplying the washer fluid of the washer fluid tank to the liquid nozzle arranged in each sensor. The liquid controller may spray the washer fluid on the desired sensor by controlling the liquid distributor 720.

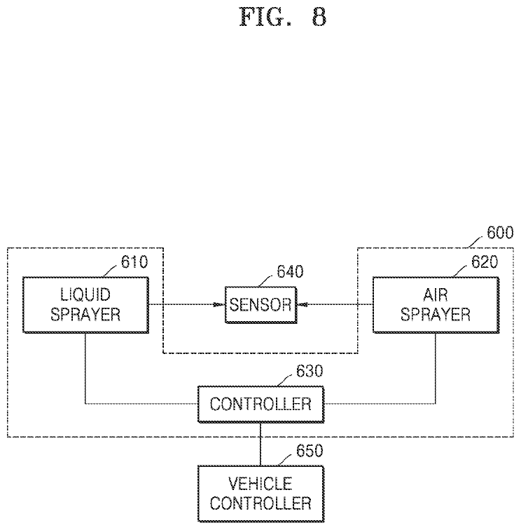

FIG. 8 is a view of another example of the vehicle sensor cleaning apparatus, according to an embodiment.

Referring to FIG. 8, a vehicle sensor cleaning apparatus 600 may include a liquid sprayer 610, an air sprayer 620, and a controller 630, The vehicle sensor cleaning apparatus 600 may be connected to a vehicle controller 650. Since the liquid sprayer 610, the air sprayer 620, the vehicle controller 650, and a sensor 640 of the present embodiment are the same as the configuration of FIG. 1, the descriptions corresponding thereto are omitted.

The present embodiment may include the controller 630 in which the liquid controller 120 and the air controller 140 of FIG. 1 are integrated. When the controller 630 receives a cleaning request from the vehicle controller 650, the liquid sprayer 610 and the air sprayer 620 may be controlled to simultaneously or sequentially spray the washer fluid and air. Each configuration and function of the liquid controller 120 and the air controller 140 may be integrally implemented in the controller 630.

The disclosure may also be implemented as a computer-readable program code on a computer-readable record medium. The computer-readable recording medium may include every type of recording device storing data readable by a computer system. Examples of the computer-readable recording media may include ROM, RAM, CD-ROM, magnetic tapes, floppy disks, optical data storage devices, etc. In addition, the computer-readable recording media may be distributed to a computer system connected by a network such that a computer-readable code may be stored and executed in a distributed method.

Regarding the disclosure, descriptions were made based on the appropriate embodiments.

According to an embodiment, the washer fluid and air may be used together to cleanly remove foreign materials on the surface of the sensor. In some embodiments, compressed air may be used to increase the spraying intensity of air. In some embodiments, after spraying the washer fluid, air may be sprayed to remove water remaining on the surface of the sensor together with foreign materials.

It should be understood that embodiments described herein should be considered in a descriptive sense only and not for purposes of limitation, Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A vehicle sensor cleaning apparatus comprising:
a liquid sprayer configured to spray washer fluid on at least one sensor arranged in a vehicle;
an air sprayer configured to spray air on the at least one sensor;
a liquid controller configured to control washer fluid spraying of the liquid sprayer; and
an air controller configured to control air spraying of the air sprayer.

2. The vehicle sensor cleaning apparatus of claim 1, wherein a washer fluid spraying direction of the liquid sprayer and an air spraying direction of the air sprayer are different from each other.

3. The vehicle sensor cleaning apparatus of claim 1, wherein the air sprayer comprises:
a compressor configured to compress and store air in an air tank; and
an air distributor configured to distribute compressed air from the air tank to at least one nozzle spraying air on a surface of the at least one sensor.

4. The vehicle sensor cleaning apparatus of claim 1, wherein the liquid sprayer comprises:
a washer pump configured to output washer fluid stored in a washer fluid tank; and
a liquid distributor configured to distribute the washer fluid to at least one nozzle spraying the washer fluid on a surface of the at least one sensor.

5. The vehicle sensor cleaning apparatus of claim 1, wherein the liquid control€er and the air controller operate alternately.

6. The vehicle sensor cleaning apparatus of claim 1, wherein, when the air controller receives information about a sensor to be cleaned from a vehicle controller, air spraying is held until information regarding finishing of the washer fluid spraying on the sensor to be cleaned is received from the liquid controller.

7. The vehicle sensor cleaning apparatus of claim 1, wherein, when the liquid controller receives information about the sensor to be cleaned from a vehicle controller, the liquid sprayer is controlled to spray the washer fluid when the air spraying of the air controller is not performed.

8. A control method of a vehicle sensor cleaning apparatus, the method comprising:
receiving a cleaning request from a vehicle controller;
spraying washer fluid on at least one sensor according to the cleaning request; and
spraying air on the at least one sensor according to the cleaning request.

9. The control method of claim 8, further comprising repeating the spraying of the washer fluid and the spraying of air a certain number of times.
